(19) United States
(12) Patent Application Publication
(10) Pub. No.: US 2010/0077218 A1
(43) Pub. Date: Mar. 25, 2010

(54) SYSTEM AND METHOD FOR ELECTRONIC DOCUMENT MANAGEMENT, ORGANIZATION, COLLABORATION, AND SUBMISSION IN CLINICAL TRIALS

(76) Inventors: Jules T. Mitchel, New York, NY (US); Joyce B. Hays, New York, NY (US)

Correspondence Address: KOHN & ASSOCIATES, PLLC, 30500 NORTHWESTERN HWY, SUITE 410, FARMINGTON HILLS, MI, 48334, US

(21) Appl. No.: 12/567,097

(22) Filed: Sep. 25, 2009

Related U.S. Application Data
(60) Provisional application No. 61/100,137, filed on Sep. 25, 2008.

(51) Int. Cl. H04L 9/32; G06F 17/30; G06F 17/00; G06F 21/00; G06F 15/16

(52) U.S. Cl. 713/176; 715/255; 726/1; 709/206; 709/204; 707/E17.005; 707/E17.044; 707/E17.008

(57) ABSTRACT

According to the present invention, there is provided a system and method for the management, organization, collaboration, and submission of electronic files and documents associated with a clinical trial. The system of the present invention enables users to create and easily access a central document repository. The system of the present invention includes various tools for the management, organization, collaboration, and editing of the documents and files stored within the system, as well as tools which enable automated regulatory submissions of required documents and files.

### FIELD OF THE INVENTION

The present invention generally relates to the field of electronic document management. Specifically, the invention relates to the areas of multi-user electronic document management, organization, collaboration, and submission in a clinical trial setting.

### DESCRIPTION OF RELATED ART

With the increasing proliferation of computers and electronic documents in nearly all workplace settings, the need for a system for managing, organizing, and sharing electronic documents becomes increasingly acute. In particular, offices which require the collaboration between several individuals on a single document must be able to track and manage the inputs of various users, while at the same time maintaining a single “master” document.

Currently, several systems exist which attempt to provide an organizational framework for multiple users to collaborate on a single document. However, these systems do not provide a comprehensive and all-encompassing solution to enable users to manage, organize, and share electronic documents in a universally accessible and intuitive format. Furthermore, presently available systems require users to undergo significant training until they are proficient in using the system. This is a significant disadvantage when the input of many users is critical to the comprehensiveness of a document or study.

Moreover, recent developments have lead to an increase in utilizing electronic tools and systems to manage clinical trials. The FDA and other regulatory agencies require those who conduct clinical trials to follow certain specific protocols with respect to the collection, management, and submission of collected clinical trial data. Though electronic systems have been developed which attempt to automate certain aspects of clinical trial data management, no comprehensive solution exists which allows users to manage, organize, store, and submit clinical trial data, while also enabling users to collaborate on the preparation of various files and documents.

### SUMMARY OF THE INVENTION

The present invention provides a system and method for the management, organization, collaboration, and submission of electronic files and documents associated with a clinical trial. The system of the present invention enables users to create and easily access a central document repository. The system of the present invention includes various tools for the management, organization, collaboration, and editing of the documents and files stored within the system, as well as tools which enable automated regulatory submissions of required documents and files.

### DESCRIPTION OF THE DRAWINGS

Other advantages of the present invention will be readily appreciated, as the same becomes better understood by reference to the following detailed description when considered in connection with the accompanying drawings wherein:

FIG. 1 represents a conceptual diagram of the architecture and sequence of the system and method of the present invention; and

FIG. 2 represents a further conceptual diagram of the architecture and sequence of the system and method of the present invention.

### DETAILED DESCRIPTION OF THE INVENTION

The present invention provides a system and method for the management, organization, collaboration, and submission of electronic documents and files associated with a clinical trial. The present invention enables users to seamlessly access, view, download/upload, and manage any document or electronic file associated with a clinical trial. System users can use the system workspace to add and organize folders, download/upload and manage documents, setup discussion forums for documents, notify document owners and subscribers of changes made to a document, track a document's history, create document routing maps for distribution to document subscribers, email, sign or reject documents, search for documents based on search keywords and work with document revisions. The system also provides users with the ability to expeditiously submit documents and/or files to regulatory agencies following established protocols.

In the preferred embodiment of the present invention, the system of the present invention is deployed over the internet, allowing multiple users to access the system simultaneously from any location equipped with an internet connection. In alternative embodiments, the system can be deployed on an internal network or intranet. While in the preferred embodiment the system's interface consists of a collection of related web-pages, in alternative embodiments the system can also be configured to operate as a stand-alone, proprietary program. The system of the present invention is engineered to enable easy implementation of additional functionality modules, as well as to allow authorized users to customize the look, feel, and operation of the system.

It should be noted that while the system and method of the present invention are directed towards clinical trial settings, the system and method of the present invention are applicable to any setting requiring the management, organization, sharing, collaboration, and submission capabilities of the present invention. Examples of such settings include law firms, academic settings, and government settings.

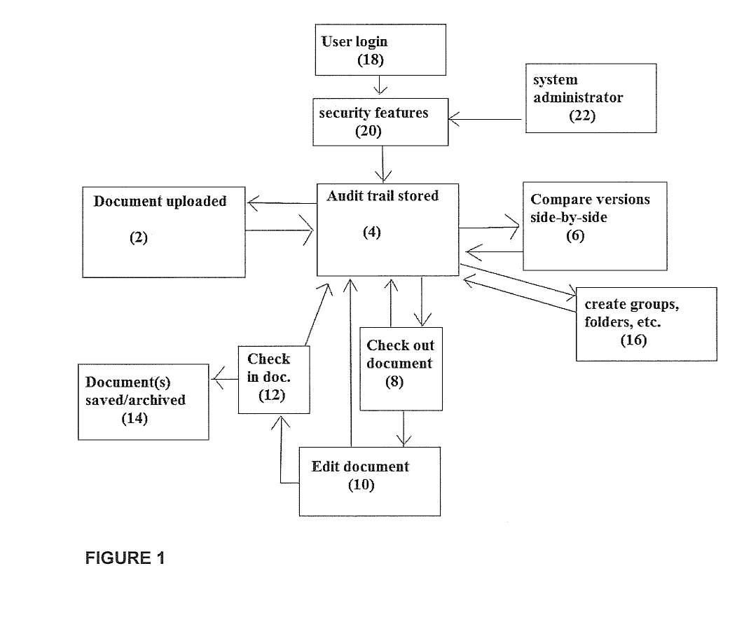

An important aspect of the present invention is the seamless management and tracking of documents and document revisions throughout the course of a document creation and management lifecycle. FIG. 1 represents a conceptual diagram of the process and architecture of the present invention. The process begins when a user logs in to the system (18) and uploads a document (2) to the document management system. Any and all system events and modifications of the document are captured and stored by the system as an audit trail (4). The system further enables users to compare side-by-side (6) earlier versions and revisions with later ones stored by the system. Furthermore, in the preferred embodiment, the system of the present invention enables authorized users to edit documents within the system itself, obviating the need for downloading and uploading documents. In an alternative embodiment, the present invention is integrated with electronic document and file editing programs (such as Microsoft Word) to allow users to use such programs to seamlessly edit and save documents and files within the system.

In order to maintain consistency within the document system, when a user wishes to edit a document, the user ‘checks out’ the document (8), which temporarily prevents any other user from making changes to the existing document. The user then proceeds to edit the document (10). When the user has finished editing the document, the user ‘checks in’ the new document (12), and this version replaces the previous one. These events are recorded in the document's audit trail (4), and the previous version of the document is also saved and archived within the system (14). All previous versions of a specific document are archived by the system, and a user with appropriate permissions has the ability to revert a document to a previously saved version.

An additional aspect of the present invention is the system's organizational functionality. The present invention enables users to efficiently create and maintain groups, categories, folders, and documents for organizing documents and files associated with different projects, clients, etc. (16). Any changes occurring within the organizational structure of the system are also tracked and stored as an audit trail (4), allowing authorized users to revert the system to previous versions if necessary, or to compare two or more incarnations of a file or file structure.

The audit trail and tracking functionalities of the present invention allow the system to be utilized in setting requiring 21 CFR Part 11 compliance, Sarbanes-Oxley requirements, and ISO 9000 (9001, 14001) documentation requirements.

The system of the present invention further includes various security features (20) to ensure that each individual user is only empowered to perform authorized tasks. For example, each system user is assigned a username and password which serves to identify the user within the system. The username and password are used each time the user logs in to the system (18). Each user has his/her own set of permissions, restricting and/or allowing the viewing, editing, and/or manipulating of specific documents and files stored within the system (20). A system administrator (22) assigns these permissions and can change a user's permissions at any time. Furthermore, the system includes further security features, whereby access to the system can be limited to specific geographic areas (such as only within the US), or even specific buildings or offices through IP address verification. This functionality allows the system's security to conform to the needs of users maintaining sensitive or confidential documents. The system of the present invention also incorporates the use of security keys and encryption which allow users to apply digital signatures to documents and files within the system.

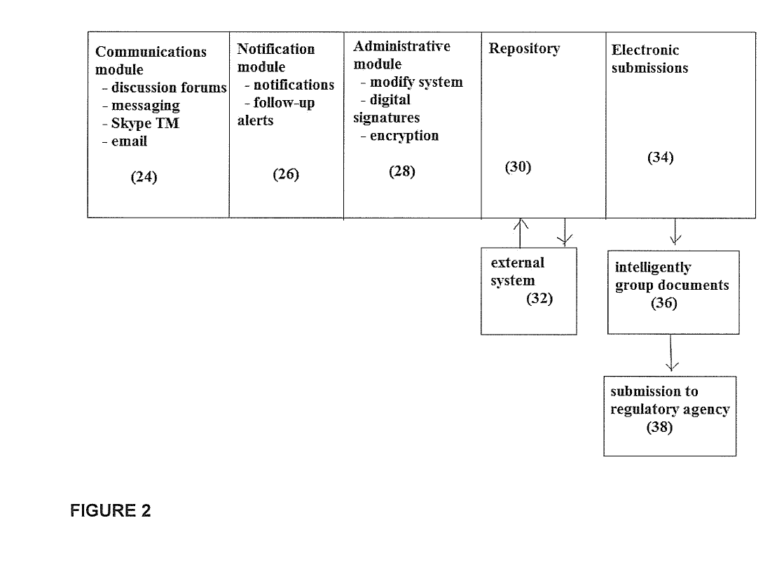

FIG. 2 represents a further conceptual diagram of the architecture and process of the present invention. The present invention includes a communications module (24) that includes a full suite of electronic communication tools that enable users to communicate with one another and collaborate on various document-related tasks. The present invention includes document discussion forums associated with each document and file within the system. In these forums, users can post messages and communicate with one another regarding the respective document, and these communications are saved by the system in the document's audit trail. Further communication functionalities include voice and text messaging, as well as internet video and/or phone calls (via such protocols such as Skype™) enable users to seamlessly communicate with one another regarding any document located within the system. An email module enables users to seamlessly email any document (or group of documents) within the system to anyone, either through the system's webmail client, or via integration with Microsoft Outlook or any other email client.

The system further includes a notification module (26) which includes a notification and alert system that allows users to schedule notifications and alerts related to specific document related tasks. Using the notification system, users can schedule follow-up or renewal alerts which remind the user to update or review a document or file at a specified time. Additionally, notifications signaling the expiration of a document can be implemented as well. The user can select the form which the notification/alert should take, such as text message, email, etc.

An administrative module (28) allows users to modify the look, feel, and operation of the system, as well as perform many administrative tasks such as assigning user permissions, as described above. The system can be configured to request and receive digital signatures associated with various documents, allowing users to request electronic signatures associated with various documents, as well as enabling users to sign these documents electronically. Users can apply digital/electronic signatures to documents and files within the system to further authenticate documents, and can also apply encryption to further secure documents.

The present invention further acts as a repository (30) of individual patient records (including, in the preferred embodiment, a data server), such as patient source records or copies of patient source records generated for any electronic data capture (EDC) system, such as those used in clinical trials. The system accepts captured data in an organized fashion in order to maintain an electronic record which can be accessed by users with appropriate permissions, such as a clinician performing a clinical trial or an auditor such as FDA. Alternatively, the system can be configured to integrate seamlessly with external electronic health records or other document management systems (32).

For example, in a clinical trial setting, the present invention can be used by the sponsor of a clinical trial such as a pharmaceutical company, biotechnology company, device company, academic institution and individual investigator. Using the system of the present invention, the user can: study a specific region, such as country, study a specific site such as a clinical investigator location or institution, and study a specific patient/subject.

The present invention further includes a module for managing electronic submissions to regulatory and other agencies (34). The system acts as a repository for clinical trial related documents that can be directly linked, without the need to drag and drop, to any electronic submission software used to make regulatory submissions, for example, eIND (investigational new drug applications,) and eCTD (electronic common technical documents). The system of the present invention intelligently groups various documents together (36) as required for various regulatory submissions and protocols. Being a document repository, the system can be configured to group various related documents together into defined document groups in order to satisfy regulatory requirements. The system can then be further configured to automatically submit these document groups to the required agency (38). The system can be configured to submit the documents using the system's own submission tool, or, in alternative embodiments, the system can be configured to submit the documents using outside/third-party submission tools/protocols, as described above.

The present invention is preferably applied in the clinical research management setting in order to maintain paperless Trial Master File documents, store and electronically sign clinical trial related documents such as protocols, monitoring reports, monitoring plans, statistical analysis plans, vendor invoices and to provide a paperless environment for regulators and auditors to oversee any clinical trial operation.

The present invention can be further integrated with any electronic data capture system (32) for uploading and organizing electronic files such as protocols, image files, photos, diagnostic tests, etc.

The invention has been described in an illustrative manner, and it is to be understood that the terminology used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

What is claimed is:

1. An integrated clinical trial document management system comprising:
document management means for generating and modifying electronic documents, organization means for creating and implementing an organizational structure, storage means for storing and archiving documents and files, tracking means for maintaining an audit trail of system events, security means for maintaining data integrity, communication means for enabling electronic communication and collaboration, notification means for implementing electronic notifications and alerts, administration means for modifying the system's operation, and submission means for submitting documents to regulatory agencies.

2. The system of claim 1, wherein said document management means includes a tool for uploading documents to the system.

3. The system of claim 1, wherein said document management means further includes a tool for comparing various revisions and versions of a document.

4. The system of claim 1, wherein said document management means further includes a tool for editing and modifying electronic documents.

5. The system of claim 1, wherein said document management means further includes a tool for restricting the number of users able to simultaneously modify a document.

6. The system of claim 1, wherein said security means includes a tool for limiting access to the system based upon a user's IP address.

7. The system of claim 1, wherein said communication means includes electronic discussion forums.

8. The system of claim 1, wherein said communication means further includes electronic messaging.

9. The system of claim 1, wherein said communication means further includes tools for electronic video and voice communication.

10. The system of claim 1, wherein said notification means includes a tool for setting follow-up and renewal alerts.

11. The system of claim 1, wherein said administration means includes a tool for requesting digital signatures.

12. The system of claim 1, wherein said submission means includes a tool for linking related documents.

13. The system of claim 1, wherein said submission means further includes a tool for electronically submitting documents and files to regulatory bodies.

14. A clinical trial document management method comprising the steps of:
generating and modifying electronic documents, creating and implementing an organizational structure, storing and archiving documents and files, maintaining an audit trail of system events, maintaining data integrity, enabling electronic communication and collaboration, implementing electronic notifications and alerts, modifying the system's operation, and submitting documents to regulatory agencies.
